(19) United States
(12) Patent Application Publication
(10) Pub. No.: US 2026/0208281 A1
(43) Pub. Date: Jul. 23, 2026

(54) ROBOT WELDING SYSTEM AND METHOD FOR OPERATING A ROBOT WELDING SYSTEM

(71) Applicant: Fronius International GmbH, Pettenbach (AT)

(72) Inventors: Manuel BINDER, Pettenbach (AT); Andreas WALDHÖR, Pettenbach (AT); Stefan PICHLER, Pettenbach (AT)

(73) Assignee: Fronius International GmbH, Pettenbach (AT)

(21) Appl. No.: 19/145,239

(22) PCT Filed: Dec. 23, 2023
(86) PCT No.: PCT/EP2023/087783

§ 371 Date: Jul. 2, 2025

(30) Foreign Application Priority Data
Jan. 2, 2023 (DE) 10 2023 100 026.8

(51) Int. Cl. B23K 9/095; B23K 9/073; B23K 9/173

(52) U.S. Cl. CPC B23K 9/0953; B23K 9/0737; B23K 9/0956; B23K 9/173

(57) ABSTRACT

The invention provides a robotic welding system (100) and a method for operating a robotic welding system. The robotic welding system (100) comprises:
a welding torch (110) with a consumable electrode (112);
a robot (120), which is configured to guide the welding torch (110);
a sensor unit (131), which is configured to carry out a scanning program by means of the robot (120) and the welding torch (110), in which a geometry of at least one workpiece (1, 2) is scanned and detected by means of the consumable electrode (11), wherein at least one position and/or orientation of the robot (120) is simultaneously detected, and wherein a cycle of advancing and retracting an electrode tip (111) of the consumable electrode (112) is periodically repeated to detect the geometry of the at least one workpiece (1, 2); and
a computing unit (132), which is configured to obtain a specification of a welding task to be carried out on the at least one workpiece (1, 2) and, based on the specification obtained and on a result of the scanning program, to generate an output signal which is designed to generate or set at least one parameter of the welding task to be carried out.

### TECHNICAL AREA

The present invention relates to a robotic welding system with a robot which guides a welding torch with a consumable electrode, and to a method for operating a robotic welding system with such a robot.

### BACKGROUND TO THE INVENTION

Robot welding systems are used to process one or more workpieces in a welding process. Even if the basic shapes of the workpieces are assumed to be known in many requirements, it can still happen that individual workpieces or the arrangement of two or more workpieces in relation to each other does not meet the expected specifications. With robotic welding systems, which are particularly advantageous when welding processes can be automated at high speed, such a situation can lead to delays or to results that do not meet the quality requirements.

It is known from EP 1 233 845 B1 that coordinates of a weld center, for example, can be determined by traversing a workpiece or several workpieces using a welding wire and simultaneously monitoring the occurrence of a short circuit.

There is also a need for improved robotic welding systems and methods for operating such robotic welding systems, in which unexpected or problematic properties of welding tasks can be detected and ideally also corrected as automatically as possible. A welding task is to be understood in particular as an arrangement of at least one workpiece to be welded, the alignment of workpieces, their quality properties and the like, as well as welding processes to be carried out on this arrangement with all associated parameters and properties.

### SUMMARY OF THE INVENTION

It is thus a task of the present invention to provide an improved robotic welding system and a corresponding method for controlling such a robotic welding system, which solves the above-mentioned task.

Accordingly, according to a first aspect of the present invention, there is provided a robotic welding system comprising:
a welding torch with a consumable electrode (or: welding rod) ;
a robot, which is configured to guide the welding torch;
a sensor unit, which is configured to carry out a scanning program by means of the robot and the welding torch, in which a geometry of at least one workpiece is scanned and detected at least in sections by means of the consumable electrode of the welding torch, wherein at least one position and/or orientation of the robot is detected at the same time; and
a computing unit, which is configured to obtain a specification of a welding task to be carried out on the at least one workpiece and, based on the obtained specification and on a result of the scanning program, to generate an output signal which is designed to generate at least one parameter of the welding task to be carried out.

In particular, the welding power source can be designed to form a voltage between the consumable electrode and a second electrode, which can be connected to at least one workpiece.

The sensor unit can be set up in such a way that a cycle is periodically repeated to detect the geometry of the at least one workpiece, which includes advancing and retracting an electrode tip of the consumable wire electrode.

In particular, the cycle which is repeated periodically may show:
Advancing an electrode tip of the consumable electrode until a short circuit between the consumable electrode and the at least one workpiece is detected via the second electrode while it is connected to the at least one workpiece,
storing the position of the consumable electrode at the time of the detected short circuit, and
retracting the electrode tip until the short circuit breaks.

The geometry of each workpiece can include internal and/or external geometric properties of the workpiece. The internal geometric properties include, for example, its dimensions, its outer contour and the like. The external geometric properties of the workpiece include, for example, its position and/or arrangement in three-dimensional space, usually with respect to a fixed coordinate system such as the coordinate system used by the welding robot.

Generating parameters means, for example, generating information or signals associated or assigned to the welding task, such as generating warning signals, filling data fields with information, generating digital flags (“flagging”) in a digital report on the execution of the welding task and the like.

Setting parameters can be understood as the initial setting of parameters (or parameter values), as well as a changing or an adjusting of parameters (or parameter values) or a selection of options from a list.

The parameter of the welding task to be performed can also be a welding process type, for example, which is automatically selected from a list of welding process types. For example, detecting the geometries of two workpieces can reveal that there is a gap between the workpieces and a suitable welding process type can be selected based on this, e.g., a pulse process, a cold metal transfer (CMT) process or similar. All parameters for the selected welding process type can then be set automatically or suggested to the user.

The robot may in particular be a robot arm or a larger robot unit, which may in particular have a robot arm for guiding the welding torch. The position and/or orientation of the robot is to be understood in particular with regard to the part of the robot that guides the welding torch. In the case of a multi-jointed robot arm, the orientation may, for example, comprise a plurality of angles in the coordinate system of each joint and the like.

When herein reference is made to “units”, it is understood that this does not necessarily mean that such units are realized as separate units distinct from each other. In cases where such units are realized as software, the units may be realized as program code sections or program code components, which may be distinguishable from each other, but which may also be interwoven. Similarly, in cases where one or more units are realized as hardware, the functions of one or more units may be realized by one and the same hardware component.

Alternatively or additionally, different functions of a single unit or also different functions of different units can be realized on one or more separate hardware components, which thus do not necessarily have to be in a 1:1 relationship with the units. In this sense, any device, system, method, etc. that has all the features and functions attributed to a particular unit can be understood as having, representing or implementing such a unit. In particular, it may be possible that all units are realized as program code which is executed on a computing device, for example by a server or a cloud computing platform.

The robot welding system as a whole can also be arranged locally. For example, the sensor unit and/or the computing unit can be integrated into the robot and/or into a welding power source of the robot welding system.

Furthermore, the invention provides a method for operating a robotic welding system with a robot guiding a welding torch with a consumable electrode, the method comprising:
Executing a scanning program by means of the robot and the welding torch, in which a geometry of at least one workpiece is scanned and detected at least in sections by means of the consumable electrode of the welding torch, at least one position and/or orientation of the robot being detected at the same time;
Obtaining a specification of a welding task to be performed on the at least one workpiece;
Generating an output signal based on the received specification and on a result of the scanning program, which is designed to generate, set or change at least one parameter of the welding task to be performed.

The method may further comprise the step of: connecting a second electrode to at least one workpiece and forming a voltage between the consumable electrode and the second electrode.

To capture the geometry of the at least one workpiece, a cycle is advantageously repeated periodically, which comprises advancing and retracting an electrode tip of the consumable electrode.

The cycle, which is repeated periodically, can comprise in particular:
Advancing an electrode tip of the consumable electrode until a short circuit between the consumable electrode and the at least one workpiece is detected via the second electrode while it is connected to the at least one workpiece,
Storing the position of the consumable electrode at the time of the detected short circuit, and
Retracting the electrode tip until the short circuit breaks.

According to some advantageous embodiments, further developments or variants, the robotic welding system further comprises a welding power source. The output signal may be designed to set a target value, a minimum value and/or a maximum value for a parameter of the welding power source for performing the welding task to be carried out. Entire parameter sets consisting of several parameters can also be set (e.g., set for the first time or changed).

The parameter may, for example, be an electrical or non-electrical parameter. The parameter can be a parameter of the welding power source, the robot, or another part or element or a procedure or process of the welding system. An electrical parameter may be a welding current, a welding voltage, a welding power and/or the like. Non-electrical parameters include, for example, a gas flow rate, a gas pre-flow and post-flow time, a wire retraction length, a wire feed speed and/or the like. Other parameters are known to the skilled person.

According to some advantageous embodiments, further developments or variants, the output signal can be designed to set a target value, a minimum value and/or a maximum value for a welding speed of the robot when performing the welding task to be carried out. For example, a depth and/or width of a gap to be welded can in turn be determined as part of the scanning program, whereby a required volume or A dimension (for a fillet weld) of filler welding material from the consumable electrode (or: welding wire electrode) can be inferred. This allows an optimum welding speed to be calculated, in particular in combination with the electrical parameters of the welding power source and optionally also with knowledge of the properties of the electrode, i.e., the welding wire to be melted. In the robotic welding system, this welding speed can then be set accordingly by the output signal and thus the robot can be controlled to control the welding torch with this calculated, optimum welding speed while performing the welding task.

According to some advantageous embodiments, further developments and variants, the output signal is designed to set a target value, a minimum value and/or a maximum value for an angle of attack of the robot when performing the welding task to be carried out. This can also be used to control the robot by means of the output signal to adopt the corresponding angle of attack and/or to perform the welding task to be carried out permanently or at least partially at the set angle of attack, depending on the requirements. As already mentioned, a geometry of a fillet weld or a butt joint, for example, can be determined as part of the scanning program and an optimum angle of attack for the welding task to be performed can be calculated based on this using the computing unit. The angle of attack can also be a temporal sequence of angles of attack, i.e., an angle of attack as a function of time during the execution of the welding task, especially if the optimum angle of attack changes once or several times during the welding task to be carried out.

According to some preferred embodiments, variants or further developments of embodiments, the output signal is designed to adjust, in particular to change, a welding position and/or a welding path of the robot for carrying out the welding task to be performed. This can be advantageous, for example, if the scanned geometry of the at least one workpiece is used to determine that the workpiece is not in a desired position, for example not in a position that was used for teaching the robot movement. The robot can have a correction program that only needs to be informed of the actual position of the workpiece, for example in explicit coordinates of the actual position and/or in the form of information about a deviation of the current position (actual position) from an expected, previously determined or preset position (target position). The correction program then automatically adjusts the learned welding position and/or welding path accordingly.

The presence of a workpiece in an incorrect position and/or alignment can be due, for example, to signs of ageing of a holding device for at least one workpiece, to deviations in the shape of at least one workpiece itself and/or to batch tolerances. In an automatic welding cell, the geometry of the workpiece, in particular its arrangement and/or alignment in space, can be recorded, for example, before each welding task, before each or for each workpiece, after a predetermined number of welding tasks or workpieces, or at regular intervals (e.g., once a day).

According to some advantageous embodiments, further developments or variants, the specification of the welding task to be performed comprises at least one requirement. The computing unit may be designed to determine, based on the result of the scanning program, whether the at least one requirement is fulfilled or not. As will be explained below, the result of whether the at least one requirement is fulfilled or not, or which and/or how many of several requirements are fulfilled or not, can be used in a variety of ways to usefully control the robotic welding system. Determining whether or not a requirement is met may include, first, determining that the requirement is definitely met, and/or second, determining that the requirement can be met but requires allowable parameter changes to the robotic welding system, and/or third, determining that a requirement is not feasible under any circumstances, either because no possible or allowable parameter change exists that would make the requirement feasible.

Modifiable (or: customizable) parameters of the robotic welding system can include, for example:
Parameters of the welding power source (current, voltage, power, gas flow rate, etc.) ;
Welding speed and/or acceleration of the robot;
Angle of attack of the robot;
Welding position and/or welding track;
and/or the like.

The inadmissibility of a parameter change that is actually possible for the robot welding system may be due, for example, to the fact that a current user of the robot welding system does not have the corresponding approvals or that a robot welding system is not currently enabled to change the necessary parameters. The robot welding system can include a user interface that can enable a user to activate one or more functions, for example the functions required to change the parameters for carrying out the welding task, in particular against payment.

According to some advantageous embodiments, further developments or variants, the robot welding system is set up in such a way that, if the computing unit comes to the conclusion that the at least one requirement cannot be fulfilled, the output signal is generated in such a way that the robot and/or a controllable holding device of at least one of the at least one workpiece are moved in such a way that the requirement is fulfilled as well as possible or completely. In other words, the output signal can be generated in such a way that feasible changes that make it possible to fulfill the at least one requirement are carried out automatically, or at least those changes that result in the best possible fulfillment of the requirement are carried out automatically. For each requirement it can be specified separately whether it must be fulfilled 100 percent or whether a partial fulfillment of the requirement is also permissible.

The robotic welding system can be set up in such a way that the welding task to be performed is only performed automatically if each of the at least one requirement is completely or at least sufficiently fulfilled. If several welding tasks are provided and one of them cannot be performed, it can be provided that those and only those welding tasks are performed whose requirement(s) are completely (or, depending on the variant, at least sufficiently) fulfilled. Alternatives can also be provided, i.e., in principle a welding task A can be provided, but if this cannot be carried out due to incomplete or insufficient fulfillment of its requirement(s), a welding task B should be carried out instead. Welding task B may, for example, involve a different type of welding process, a different type of seam and/or the like.

According to some advantageous embodiments, further developments or variants, the welding task comprises at least two workpieces. The at least one requirement may comprise a relative positioning between the at least two workpieces. For example, a requirement may comprise a maximum width of a gap between two plate-shaped workpieces in the butt joint, a maximum angle between two workpieces and/or the like. The requirement can either be a yes/no requirement, i.e., it can either be fulfilled or not, it can be a the-more-the-better requirement, or a combination thereof. In the case of a yes/no requirement, for example, it can be required that the gap of the butt joint is at the most x mm. In the case of a the-more-the-better requirement, it can be specified that the gap should be as small as possible. In the case of a combined requirement, it can be specified that the gap should be as small as possible, but no more than x mm. Accordingly, the output signal can be generated in such a way that the robot and/or a controllable holding device for at least one of the at least two workpieces is or are controlled in such a way that the requirement is fulfilled.

According to some advantageous embodiments, further developments or variants, the output signal is designed to generate, as a parameter of the welding task to be performed, information about an expected quality of a result of the welding task performed. The expected quality can, for example, be based on the geometric dimensions of the at least one workpiece or the relative arrangements of at least two workpieces to each other, which can be known on the basis of the scanning program of the computing unit. The calculation of the information about the expected quality can also include further information known to the computing unit, such as information about the capabilities of the robot welding system, in particular the welding torch, information about properties of the at least one workpiece, such as material properties, information about a time available for the welding task to be performed and/or the like.

According to some advantageous embodiments, further developments or variants, the at least one requirement comprises a requirement for the expected quality of the welding task performed. The output signal can be designed to instruct the welding task for the at least one workpiece to be aborted if the expected quality does not correspond to a predetermined minimum quality. In this way, it is possible to avoid wasting valuable time and resources of the robotic welding system on an inferior product. Preferably, the expected quality of the performed welding task is calculated after all feasible parameter changes have been adjusted to maximize the fulfillment of all existing requirements for the welding task.

According to some advantageous embodiments, further developments or variants, the at least one requirement comprises a requirement for a geometric property of at least one of the at least one workpiece. The output signal can be designed to instruct a termination of the welding task for the at least one workpiece if the geometric property is not present. The geometric property of the at least one workpiece can be determined in particular by the scanning program. In this way, a time-consuming and/or costly inspection of workpieces to be welded in advance can be omitted and can instead be carried out automatically by the robot welding system as part of the scanning program. A geometric property to be fulfilled can be, for example, a desired minimum thickness or maximum thickness of a plate-shaped workpiece (sheet metal).

According to some preferred embodiments, variants or refinements of embodiments, the cycle is repeated at a frequency between 10 Hz and 500 Hz, preferably between 30 Hz and 300 Hz, particularly preferably between 75 Hz and 125 Hz.

According to some preferred embodiments, variants or refinements of embodiments, the sensor unit is adapted to receive information signals of the robot in addition to position signals with the positions of the electrode tip. The information signals of the robot may, for example, indicate a respective position and/or orientation of the robot.

The sensor unit can be configured to provide all position signals and/or information signals (or at least those position signals and/or information signals which do not have their own time stamp) with a time stamp, so that a connection between the positions and orientations of the robot in i its time and coordinate system, on the one hand, and the stored positions of the electrode tip of the wire electrode, on the other hand, is established via the common time stamps.

Advantageously, the robot moves along a scanning path to scan the at least one workpiece independently of the cycle of the wire electrode.

According to some advantageous embodiments, further developments or variants, the method further comprises performing the welding task comprising the at least one generated, set or modified parameter by means of the robot and the welding torch.

The output signal can be designed to automatically select a suitable welding process type from a list of welding process types. The welding task can be carried out using the selected welding process type.

Further information, which may represent parameters of the welding task, may include, for example, information on which parameter changes were made to ensure that at least one requirement of the specification of the welding task to be performed could be met and/or the like.

According to a further aspect, the invention provides a computer program product comprising executable program code which, when executed, is adapted to perform the method of one embodiment of the present invention.

According to a further aspect, the invention provides a non-transitory, computer-readable data storage medium comprising executable program code which, when executed, is adapted to perform the method of one embodiment of the present invention. The data storage medium may be, for example, a hard disk, a solid-state storage device, a CD, a DVD, a memory card and the like.

According to a further aspect, the invention provides a data stream or data structure comprising or adpated to generate executable program code, and wherein the executable program code is adapted, when executed, to perform the method of an embodiment of the present invention.

Further preferred embodiments, variants and further embodiments of embodiments are shown in the dependent claims and in the description with reference to the figures.

### BRIEF DESCRIPTION OF THE FIGURES

The invention is explained in more detail below with reference to examples of embodiments in the figures of the drawings. The partially schematized illustration shows:

FIG. 1 a schematic representation of a robotic welding system according to a first embodiment of the present invention;

FIG. 2a) an illustrative representation of the execution of a scanning program;

FIG. 2b) a first result of the scanning program from FIG. 2a);

FIG. 3a) an illustrative representation of the execution of a further scanning program;

FIG. 3b) a first result of the scanning program from FIG. 3a);

FIG. 4a) to FIG. 4f) various graphs to illustrate possible signal processing and use of the results of a scanning program;

FIG. 5a) to FIG. 5n) schematic diagrams to illustrate possible welding situations or problems with the arrangement or properties of workpieces;

FIG. 6a) to FIG. 6i) schematic diagrams to illustrate other possible welding situations or problems with the arrangement or properties of workpieces;

FIG. 7 a schematic flow chart explaining a method according to a further embodiment of the present invention;

FIG. 8 a schematic block diagram illustrating a computer program product according to another embodiment of the present invention; and

FIG. 9 a schematic block diagram illustrating a data storage medium according to still another embodiment of the present invention.

In all figures, identical or functionally identical elements and devices have been given the same reference signs, unless otherwise indicated. The designation and numbering of the method steps does not necessarily imply a sequence, but serves the purpose of better differentiation, although in some variants the sequence can also correspond to the sequence of the numbering.

### DETAILED DESCRIPTION OF THE FIGURES

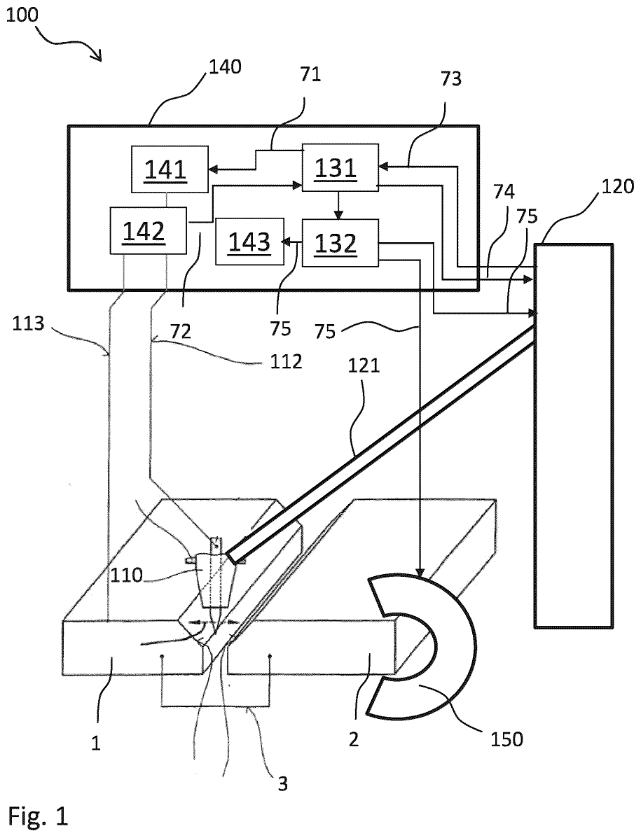

FIG. 1 shows a schematic representation of a robotic welding system 100 according to a first embodiment of the present invention. The robotic welding system 100 comprises a welding torch 110 which guides a consumable wire electrode 112 (i.e., a welding wire), and which in turn is guided by a robot 120, in particular a robot arm 121, of the robotic welding system 100.

A welding power source 140 of the robotic welding system 100 is designed to form a voltage between the consumable wire electrode 112 and a second electrode 113, which can be connected to a workpiece 1, 2.

One or more holding devices 150, of which in turn one or more can be controllable, can also be provided for holding and/or arranging at least one of the workpieces 1, 2. Such holding devices 150 can also be part of the robotic welding system 100 and can advantageously also be controlled by the latter. A holding device 150 can, for example, be another robot, e.g., a robot arm.

The robot welding system 100 also comprises a sensor unit 131, which is designed and configured to carry out a scanning program by means of the robot 120 and the welding torch 110, in which a geometry of at least one workpiece 1, 2 is scanned and detected at least in sections by means of the consumable wire electrode 112 of the welding torch 110. At the same time, at least one position and/or orientation of the robot 120 is detected, for example by means of an information signal 73 of the robot 120. In combination, it is thus possible to determine the geometric properties (length, height, size, outer contour) and the relative arrangement of several workpieces 1, 2 to one another, for example.

In the situation shown in FIG. 1, the sensor unit 131 is integrated into the welding power source 140 as an example, but other arrangements are also conceivable, for example integration into the robot 120, a separate arrangement in a separate housing, and/or a remotely arranged sensor unit 131 (for example implemented by a remotely arranged server, a cloud computing platform or the like).

To carry out the scanning program, the sensor unit 131 can in particular comprise a wire feed device 141 of the robot welding system 100, or the wire feed device 141 and the sensor unit 131 can be set up in such a way that the sensor unit can control the wire feed device 141, in particular to carry out the scanning program. For this purpose, the sensor unit 131 can send control signals 71 to the wire feed device 141. In the variant shown, the wire feed device 141 is part of the welding power source 140. Other embodiments are known to the skilled person, so they will not be discussed in more detail here.

The sensor unit 131 can also have a voltage measuring device (among other things) for short-circuit detection or be set up to receive and evaluate detection signals 72 from a voltage measuring device 142 of the welding power source 140 (as shown in FIG. 1).

To carry out the scanning program, the sensor unit 131 can instruct the wire feeding device 141 to advance the consumable wire electrode 112 at a predefined speed until it detects a short circuit between the consumable wire electrode 112 and the workpiece 1 (via the further electrode 113) based on the detection signals 72 of the voltage measuring device 142. An electrical connection 3 between the workpieces 1, 2 (usually provided by a clamping device or holding device) ensures that short circuits between the consumable wire electrode 112 and both workpieces 1, 2 can be detected.

The corresponding position (“initial position”) of the wire electrode 112 when the short circuit occurs can, for example, be measured and stored by a motor encoder of the wire feed device 141 and/or by the sensor unit 131. The first determined position of the workpiece 1 can be defined as a reference distance, e.g., as a zero line. The electrode tip of the wire electrode 112 is then retracted until the short circuit breaks, and the cycle of advancing, storing the position and retracting is repeated periodically, e.g., at a frequency between 10 Hz and 500 Hz, preferably between 30 Hz and 300 Hz, particularly preferably between 75 Hz and 125 Hz. The position information of the welding wire is recorded each time in the event of a short circuit.

In addition to the positions of the electrode tip, the sensor unit 131 also receives the information signals 73 of the robot 120. All signals converging at the sensor unit 131 can be provided with a time stamp by the sensor unit 131, so that a relationship between the positions and orientations of the robot 120 in its time and coordinate system, on the one hand, and the stored positions of the electrode tip of the wire electrode 112, on the other hand, is established via the common time stamps.

Alternatively, the position signals and/or the information signals 73 of the robot can also be provided with their own time stamps, whereby the sensor unit 131 provides only those signals which do not have their own time stamps with time stamps and calculates a one-to-one correlation between the/all received and/or the self-generated time stamps and uses them in the further course for the temporal correlation of positions of the electrode tip and position and orientation of the robot 120. The variant in which the sensor unit 131 provides all signals with time stamps is described in more detail below, without the invention being intended to be limited to this. However, the phrase “common time stamps” is always intended to mean that one of the aforementioned (or other known) methods is used to correlate the signals and time stamps in order to obtain signals or positions and orientations that are correlated with each other in time.

Thus, the robot 120 can be instructed (for example by the sensor unit 131 or another element of the robotic welding system 100) to move the wire electrode 112 in a direction perpendicular to the wire feed direction along a scanning path as part of the scanning process. Since the data is linked via the common time stamp, the-usually significantly slower-movement of the robot 120 can take place independently of the cycle of moving the wire electrode 112 back and forth.

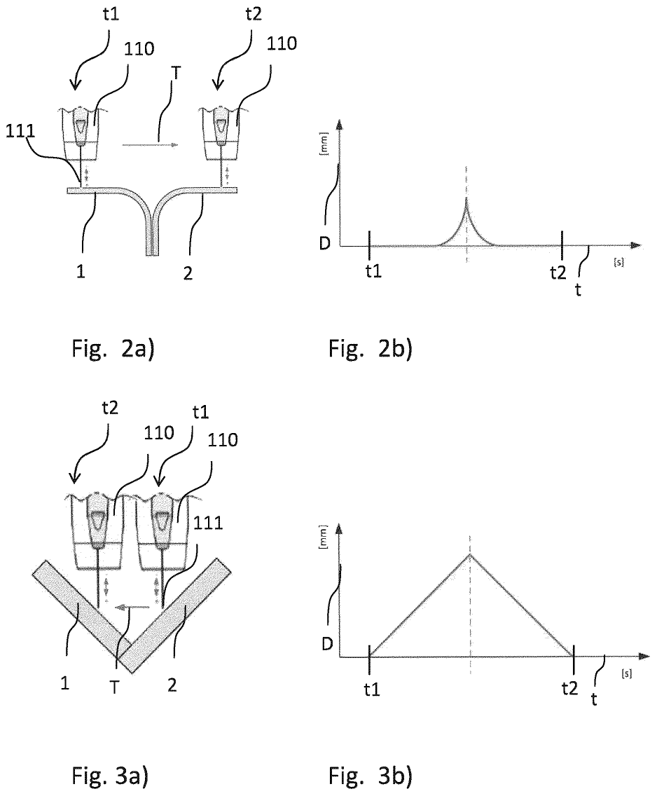

FIG. 2a) to FIG. 3b) explain this procedure.

In both FIG. 2a) and FIG. 3a), the welding torch 110 (more precisely: the tip of the contact tube of the welding torch 110) is shown both at a first point in time t1 and at a later point in time t2. At time t1, the electrode tip 111 of the consumable wire electrode 112 touches a first workpiece 1, which is to be welded to a second workpiece 2 in a beaded seam according to the welding task in FIG. 2a), and is to be welded in a fillet weld according to the welding task in FIG. 3a).

FIG. 2b) and FIG. 3b) show the feed path D of the electrode tip 111 from the starting position at time t1 to the end position of the scanning program at time t2 as a function of time t in seconds. The welding torch 110 is moved by the robot 120 along a scanning trajectory T, which preferably extends perpendicular to the weld seam to be performed (in FIGS. 2a) and 3a) into the drawing plane). The scanning trajectory T is preferably a straight line in space. For some welding tasks, such as that of FIG. 2a), it is advantageous if the scanning trajectory T also extends at least partially parallel to at least one surface of at least one workpiece 1, 2.

FIGS. 2b) and 3b) already show schematically how, in this way, comprehensive geometric information can be generated about the geometric properties of both the workpieces 1, 2 and their arrangement in relation to each other.

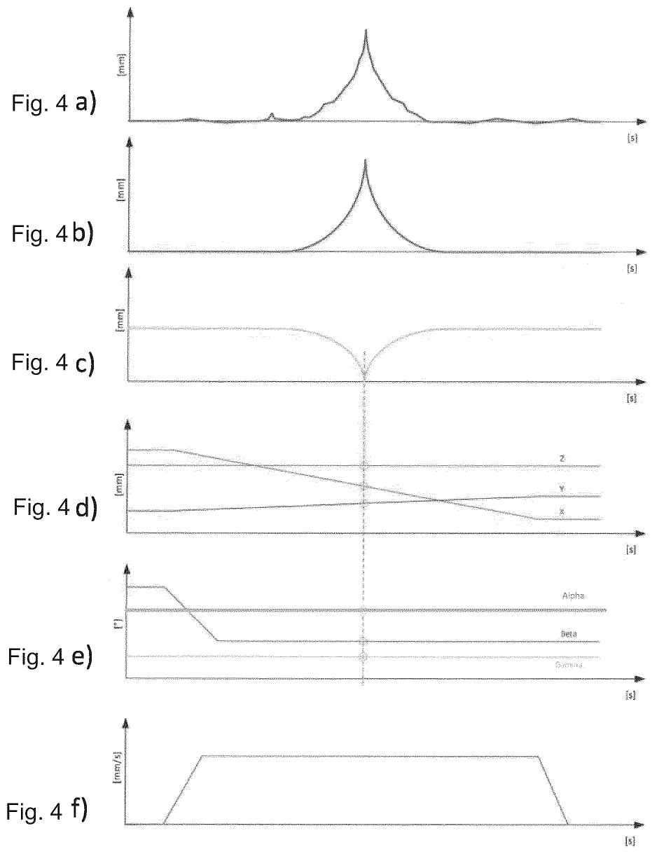

FIG. 4a) to f) explain the further processing in more detail using the welding task in FIG. 2a) and FIG. 2b). The association or correlation of the various signals via the common horizontal axis can be clearly seen using the common time stamps.

FIG. 4a) shows the raw signal as it is generated according to the procedure described in FIG. 2a) to FIG. 3b). FIG. 4b) shows a filtered (smoothed) signal based on this. FIG. 4c) shows how the actual geometry of the welding situation (i.e., the workpieces 1, 2 and their arrangement) can be extracted from the signal of FIG. 4b). For this purpose, the sensor unit 131 may have information about the welding task, for example information about which welding situation is to be present and/or which type of weld seam is to be produced in the welding task. Thus, the sensor unit 131 can have ideal parameterizations of curves, as shown in FIG. 4c), depending on the welding task and/or weld seam, for which the signal of FIG. 4b) is analyzed and processed by mathematical methods, e.g., filtered and/or fitted, in order to determine the present shape and configuration of the workpieces.

FIG. 4d) shows the positions of the robot 120 as a function of time in X, Y and Z coordinates of a predefined coordinate system, which can, for example, be connected to the robot 120 in a fixed position. FIG. 4e) accordingly shows the orientation of the robot 120 in three angles alpha, beta and gamma. This information can be available to the sensor unit 131 either through information signals 73 from the robot 120 to the sensor unit 131. Alternatively, the sensor unit 131 can also be set up to send control signals 74 to the robot 120 for the movement of the robot 120. In this case, the position, orientation, etc. of the robot 120 can be detected using the control signals 74. FIG. 4f) shows a tool center point speed of the robot 120.

Again with reference to FIG. 1, the robotic welding system 100 further comprises a computing unit 132, which is arranged to obtain a specification of a welding task to be performed on the at least one workpiece 1, 2 and to generate an output signal 75 based on the obtained specification and on a result of the scanning program, which is designed to generate or set at least one parameter of the welding task to be performed. Depending on which parameter is generated or set, the output signal 75 can be sent to various elements, for example to the robot 120, to power electronics 143 of the welding power source 140, to one or more holding devices 150 and/or the like.

The parameter or the several parameters may, in particular, as already explained in the foregoing, be parameters of the welding power source 140 (current, voltage, power), a welding speed and/or acceleration of the robot 120, one or more angles of attack of the robot 120, a welding position or a welding path, a welding process type and/or the like, and each time again a minimum value, a maximum value, a target value and so on.

The number and type of parameter changes depends on the welding task and the detected geometries. For example, the computing unit 132 may have the information that the welding task comprises the welding of a fillet weld with a melting wire electrode 112. The geometry of the welding situation detected by the scanning program can include, for example, an angle between the workpieces 1, 2, which requires an adjustment of the angle of attack of the robot 120.

Similarly, a width of a gap at a butt joint can be detected by the scanning program, a necessary amount of melted material of the melting wire electrode 112 can be calculated based thereon, and the welding speed (or movement speed of the robot 120 along the weld seam), a welding current (electrical output current of the welding power source), a welding position, a welding path, a welding process type and the like can be set (e.g., adjusted) based thereon.

The computing unit 132 can also have information about all parameters that can be changed, as well as requirements for the welding task. For example, it may be provided that the angle between the workpieces 1, 2 is ideally 90° for a fillet weld such as in FIG. 3a).

If the sensor unit 131 determines, by means of the scanning program, that the angle is currently 80°, for example, there are various possibilities. In the event that the computing unit 132 has access to a controllable holding device 150 for at least one of the workpieces 1, 2, by means of which the angle can be changed, it can be provided that the computing unit 132 controls this controllable holding device 150 by means of the output signal 75 to set the angle as well as possible to 90°. If the welding task includes a tolerance for the angle, for example allowing a deviation of +/−5°, the holding device 150 can be controlled to change the angle to at least 85° to 95°, whereby the set angle should be as close as possible to 90°.

In other cases, the welding task may include further requirements and/or information about the quality of the welding task to be performed. For example, it may specify that an angle of 890-91° allows the welding task to be performed with high quality, an angle between 85° and 95° allows the welding task to be performed with reduced quality, and any other angle does not allow an acceptable quality.

In this case, it may be provided that the computing unit 132 first controls the holding device 150 to produce an angle as close as possible to 90°. If the result is known exactly, it is possible to continue; if not, the computing unit 132 can instruct the sensor unit 131 to carry out a further scanning program in order to record the result of the control of the holding device 150. If necessary, this can also be carried out several times until no further improvement is possible. Based on the finally set angle, it can then be determined whether the welding task can now be carried out with high quality, reduced quality or unacceptable quality, and whether the welding task should nevertheless be carried out. This means that the welding task can also be aborted if an acceptable quality cannot be achieved.

The welding task may comprise or provide a data structure in which a report on the performed welding task is generated by the robotic welding system 100. This report may comprise information about the final quality of the performed welding task (or, in other words, the finished welded workpiece).

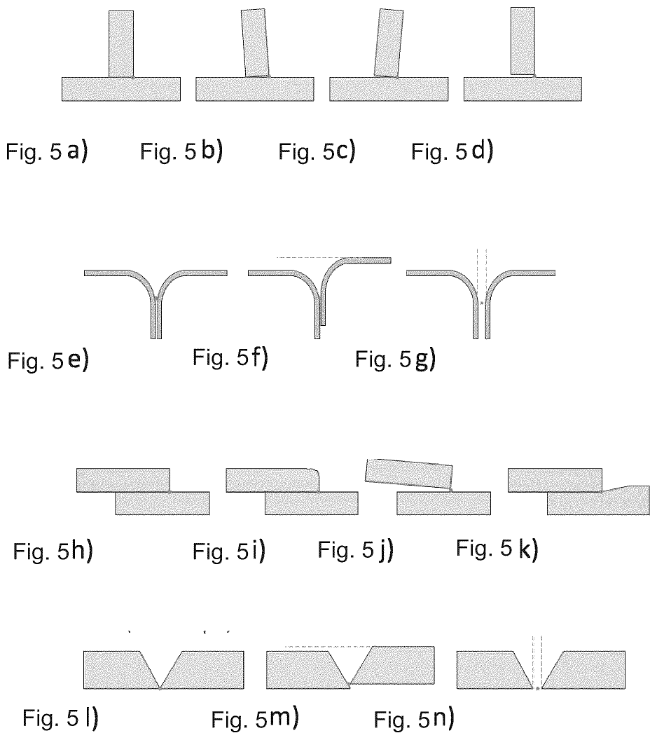

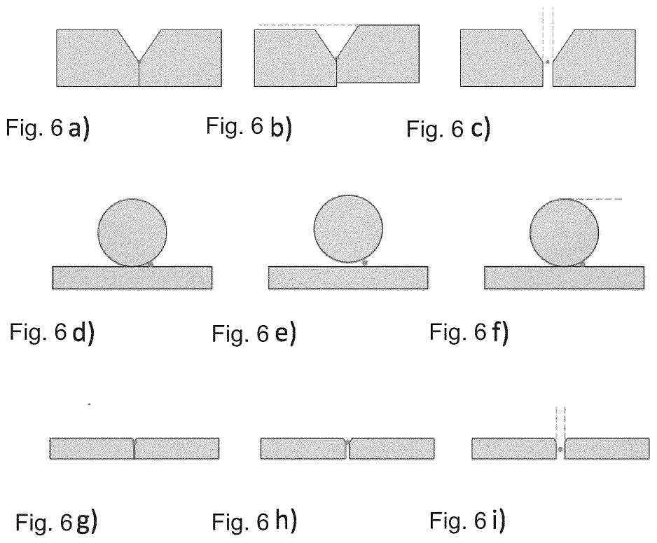

FIG. 5 and FIG. 6 serve to explain various possible welding situations, how the scanning program can detect them and what conclusions can be drawn from them. The welding situations shown do not have to be faulty, but can also be desired in this form, for example by requiring a certain gap width, a certain offset between two workpieces, etc. If a desired welding situation is present, a parameter can be generated which indicates that this was the case, for example for a downstream quality control.

In the event that the present situations are undesirable (e.g., a gap, an offset, an angle etc. is present although none should be present, or vice versa), parameters of the welding task can be set accordingly, as described above and in the following, in order to improve the result of the welding task.

FIG. 5a) to 5d) illustrate a welding task with fillet weld. In this case, one of the workpieces may be displaced in relation to the other (FIG. 5a)), the vertical workpiece may not lie flush against the horizontal workpiece (FIG. 5b), FIG. 5c)), or there may be a gap between the workpieces (FIG. 5d)).

FIG. 5e) to 5g) illustrate a welding task with a flanged seam. Here there may be a gap (FIG. 5e), FIG. 5g)) or a height offset between the two workpieces (FIG. 5f)).

FIG. 5h) to 5k) illustrate a welding task with an overlap seam. In this case, there may be a horizontal displacement (FIG. 5h)), one of the workpieces may be degraded, for example have an unclean edge (FIG. 5i)), a gap and/or a non-zero angle may occur between the workpieces (FIG. 5j)), or there may be bevels in front of the weld edge (FIG. 5k)). The same welding situations can occur with three-sheet joints, in each case between two adjacent sheets (workpieces).

In some variants, degraded workpieces that are detected by the scanning program can also lead to the welding task not being performed (i.e., aborted) with this or these specific workpieces due to corresponding requirements contained in the specification of the welding task. Alternatively, the welding task can still be carried out, whereby the condition of the workpieces and/or the quality of the final welded workpiece is recorded in the report on the welding task carried out.

FIG. 5l) to 5n) illustrate a welding task with a V-seam, either with or without a gap. Here, workpieces can lie against each other without a gap (FIG. 5l)) or separated by a gap (FIG. 5n)), or there can be a height offset of the two workpieces (FIG. 5m)) or an angular offset (not shown).

FIG. 6a) to 6c) illustrate a welding task with a Y-seam. Here, the notch can be symmetrical (FIG. 6a)), the workpieces can be offset (FIG. 6b)) or there can be a gap between the workpieces (FIG. 6c)).

FIG. 6d) to 6f) illustrate a welding task with a round bar on a metal sheet. In this case, the round bar can rest on the sheet metal (FIG. 6d)) or there can be a gap between the round bar and the sheet metal (FIG. 6e)). However, the scanning program can also determine that the round bar as one of the workpieces has the wrong geometric properties, such as the wrong radius or a deviation from the circular shape (FIG. 6f)).

FIG. 6g) to 6i) illustrate a welding task with a butt weld. Here, the workpieces can lie flush against each other (FIG. 6g)) or be separated by a gap (FIG. 6i)). The geometric properties of a chamfer on a workpiece edge can also be detected (FIG. 6h)), and thus also whether it has undesirable properties (wrong size, wrong angle, etc.) , for example.

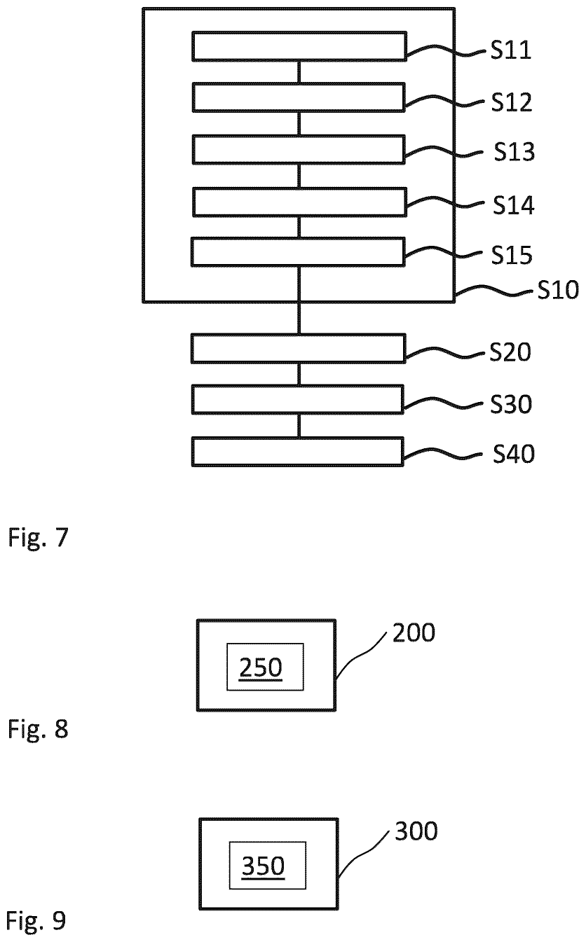

FIG. 7 shows a schematic flow diagram for explaining a method according to one embodiment of the present invention, namely a method for operating a robotic welding system with a robot which guides a welding torch with a consumable electrode.

In a step S10, a scanning program is carried out by means of the robot 120 and the welding torch 110, in which a geometry of at least one workpiece 1, 2 is scanned and detected at least in sections by means of the consumable wire electrode 112 of the welding torch 110, whereby at least one position and/or orientation of the robot 120 is detected at the same time. This can be done, for example, as described in detail in the foregoing, in particular with reference to FIG. 1 to FIG. 6.

In particular, the following steps can be carried out as part of the scanning program, especially in numerical order:

In a step S11, the welding torch 110 is positioned with the electrode tip 111 at a predefined position. The predefined position can be defined with respect to a workpiece 1, 2 or with respect to the robot 120. This can be, for example, a position at which the electrode tip 111 is in contact with a workpiece 1, 2 (detectable, for example, by means of short-circuit detection), or a position at which it is ensured that there is no contact.

Subsequently, in a step S12, the robot 120 is controlled to move the electrode tip 111 in a defined scanning trajectory over at least a part of at least one workpiece 1, 2, whereby information signals 73 with the coordinates and orientations (for example x, y, z positions as well as alpha, beta, gamma angles) are regularly generated and provided with a time stamp with respect to a central clock. Preferably, the scanning trajectory runs at least partially perpendicular to the planned course of the weld seam and/or at least partially parallel to at least one surface of a workpiece 1, 2.

In a step S13, the electrode tip 111 is advanced until a short circuit between the electrode tip 111 and a workpiece 1, 2 is detected, and a position of the electrode tip 111 along the axis of the wire feed movement when the short circuit occurs is stored, wherein the position is also recorded together with a time stamp of the central clock.

In a step S14, the electrode tip 111 is retracted again, for example by means of a wire feed device 141, until there is no longer a short circuit.

Steps S13 and S14 are repeated along the scanning trajectory I, whereby the number of cycles (scanning density) can also depend on the welding task, but can also be user-adjustable. The cycle of advancing S13, storing the position and retracting S14 is repeated, for example, at a frequency between 10 Hz and 500 Hz, preferably between 30 Hz and 300 Hz, particularly preferably between 75 Hz and 125 Hz.

The time stamps are preferably assigned at a frequency (e.g., 1000 Hz) which is greater both than a) the frequency of the steps S13+S14 and b) the frequency at which the information signals 73 of the robot 120 are received.

In a step S15, the acquired geometry data (i.e., the stored positions with time stamps) of the electrode tip 111 and the robot coordinates (positions and angles from the information signals 73) of the robot 120 are evaluated in order to obtain the desired information about the geometry and/or the position of the at least one workpiece 1, 2, for example as described with reference to FIG. 4 in the foregoing. This way the data is merged, in particular via the common time stamp, i.e., a common time base.

In a step S20, a specification of a welding task to be performed on the at least one workpiece 1, 2 is received, for example together with the welding task, via a data interface, a data carrier or the like. The receiving S20 can be wired or wireless.

In a step S30, an output signal is generated based on the specification received and on a result of the scanning program, which is designed to generate, set or change at least one parameter of the welding task to be performed. This can be done, for example, as described in detail above, in particular with reference to FIG. 1 to FIG. 6.

Adjusting the parameter can serve the purpose of being able to perform the welding task at all, improving the expected quality of the workpiece to be produced in the welding task, providing improved documentation (for example, information about the quality of the workpiece produced), improving the efficiency of performing the welding task (reduced speed, reduced dead time between two welding tasks, etc.) and/or the like.

In a step S40, the welding task, which comprises or takes into account the at least one generated, set or modified parameter, is performed by means of the robot 120 and the welding torch 110. In particular, the at least one workpiece 1, 2 can be welded in step S40.

FIG. 8 shows a schematic block diagram illustrating a computer program product 200 according to one embodiment of the present invention. The computer program product 200 comprises executable program code 250 which, when executed, is adapted to perform the method according to one embodiment of the present invention, in particular the method described with reference to FIG. 7.

FIG. 9 shows a schematic block diagram illustrating a non-transitory computer readable data storage medium 300 according to one embodiment of the present invention. The data storage medium 300 includes executable program code 350 which, when executed, is adapted to perform the method according to one embodiment of the present invention, in particular the method described with reference to FIG. 7.

In the preceding detailed description, various features have been summarized in one or more examples to improve the stringency of the presentation. However, it should be understood that the above description is merely illustrative and in no way limiting. It is intended to cover all alternatives, modifications and equivalents of the various features and embodiments. Many other examples will be immediately and directly obvious to a person skilled in the art in view of the above description.

The embodiments have been selected and described in order to best illustrate the principles underlying the invention and its possible applications in practice. This enables those skilled in the art to optimally modify and utilize the invention and its various embodiments with respect to the intended use. It is further understood that units described as separate may be partially integrated with one another.

### LIST OF REFERENCE SYMBOLS

1 workpiece
2 workpiece
3 electrical connection
71 control signal
72 detection signal
73 information signal
74 control signals
75 output signal
100 robotic welding system
110 welding torch
111 electrode tip
112 consumable wire electrode
113 further electrode
120 robot
121 robot arm
131 sensor unit
132 computing unit
140 welding power source
141 wire feed device
142 short-circuit detector device
143 power electronics
150 holding device
200 computer program
250 program code
300 data storage medium
350 program code
D feed path
t time
t1, t2 time points
T scanning trajectory
S10 . . . S40 method steps

1. Robotic welding system comprising:
a welding torch with a consumable electrode;
a robot, which is configured to guide the welding torch;
a welding power source, which is designed to form a voltage between the consumable electrode and a second electrode, which can be connected to at least one workpiece;
a sensor unit, which is configured to carry out a scanning program by means of the robot and the welding torch, wherein the scanning program is configured to scan and detect a geometry of the at least one workpiece at least in sections by means of the consumable electrode of the welding torch, wherein the scanning program is further configured to detect at least one position and/or orientation of the robot at the same time, wherein the sensor unit is configured, in order to detect the geometry of the at least one workpiece, to repeat a periodic cycle, wherein the cycle comprises:
advancing an electrode tip of the consumable electrode until a short circuit between the consumable electrode and the at least one workpiece is detected via the second electrode while the latter is connected to the at least one workpiece,
storing the position of the consumable electrode at the time of the detected short circuit, and
retracting the electrode tip until the short circuit breaks; and
a computing unit, which is configured to obtain a specification of a welding task to be carried out on the at least one workpiece and, based on the specification obtained and on a result of the scanning program, to generate an output signal which is designed to generate or set at least one parameter of the welding task to be carried out.

2. Robotic welding system according to claim 1, wherein the computing unit is configured to set, via the output signal, a target value, a minimum value and/or a maximum value for a parameter of the welding power source when performing the welding task to be carried out.

3. Robotic welding system according to claim 1,
wherein the computing unit is configured to set, via the output signal, a target value, a minimum value and/or a maximum value for a welding speed of the robot when performing the welding task to be carried out.

4. Robotic welding system according to claim 1,
wherein the computing unit is configured to set, via the output signal, a target value, a minimum value and/or a maximum value for an angle of attack of the robot when performing the welding task to be carried out.

5. Robotic welding system according to claim 1,
wherein the computing unit is configured to set, via the output signal, a welding position and/or a welding path of the robot for performing the welding task to be carried out.

6. Robotic welding system according to claim 1,
wherein the specification of the welding task to be performed comprises at least one requirement, and wherein the computing unit is adapted to determine whether or not the at least one requirement is fulfilled based on the result of the scanning program.

7. Robotic welding system according to claim 6,
wherein, if the computing unit comes to the conclusion that the at least one requirement is not fulfilled, the output signal is generated in such a way that the robot and/or a controllable holding device for at least one of the at least one workpiece are moved in such a way that the requirement is fulfilled as well as possible or completely.

8. Robotic welding system according to claim 7,
wherein the welding task comprises at least two workpieces and the at least one requirement comprises a requirement for a relative positioning between the at least two workpieces.

9. Robotic welding system according to claim 6,
wherein the computing unit is configured to generate, via the output signal, as a parameter of the welding task to be performed, information about an expected quality of a result of the welding task performed.

10. Robotic welding system according to claim 9,
wherein the at least one requirement comprises a requirement for the expected quality of the welding task performed; and
wherein the output signal is designed to instruct a termination of the welding task for the at least one workpiece if the expected quality does not correspond to a predetermined minimum quality.

11. Robotic welding system according to claim 6,
wherein the at least one requirement comprises a requirement for a geometric property of at least one of the at least one workpiece; and
wherein the computing unit is configured to instruct, via the output signal, a termination of the welding task for the at least one workpiece if the geometric property is not present.

12. Robotic welding system according to claim 1, wherein the sensor unit is configured to repeat the cycle at a frequency between 10 Hz and 500 Hz.

13. Robotic welding system according to claim 1, wherein the sensor unit is adapted to receive information signals of the robot in addition to position signals comprising the positions of the electrode tip.

14. Robotic welding system according to claim 13, wherein the sensor unit is configured to provide all position signals and/or information signals or at least those position signals and/or information signals which do not have their own time stamp with a time stamp, so that a relationship is established between the positions and orientations of the robot in its time and coordinate system, on the one hand, and the stored positions of the electrode tip of the wire electrode, on the other hand, via the common time stamps.

15. Robotic welding system according to claim 14, which is further configured such that a movement of the robot along a scanning path for scanning the at least one workpiece takes place independently of the cycle of the wire electrode.

16. Method of operating a robotic welding system with a robot that guides a welding torch with a consumable electrode, comprising:
connecting a second electrode to at least one workpiece and forming a voltage between the consumable electrode and the second electrode; executing a scanning program by means of the robot and the welding torch, wherein the scanning program is configured to scan and detect a geometry of at least one workpiece at least in sections by means of the consumable electrode of the welding torch, wherein the scanning program is further configured to detect simultaneously at least one position and/or orientation of the robot, wherein a cycle is repeated periodically in order to detect the geometry of the at least one workpiece, wherein the cycle comprises:
advancing an electrode tip of the consumable electrode until a short circuit between the consumable electrode and the at least one workpiece is detected via the second electrode while the latter is connected to the at least one workpiece,
storing the position of the consumable electrode at the time of the detected short circuit, and
retracting the electrode tip until the short circuit breaks;
obtaining a specification of a welding task to be performed on the at least one workpiece;
generating an output signal based on the received specification and on a result of the scanning program, which is designed to generate, set or modify at least one parameter of the welding task to be performed.

17. The method according to claim 16, comprising performing the welding task comprising the at least one generated, set or modified parameter by means of the robot and the welding torch.

18. The method according to claim 17, wherein a suitable welding process type from a list of welding process types is automatically selected via the output signal, and the performing of the welding task is carried out by means of the selected welding process type.

19. Computer program product comprising executable program code which, when executed to control a robotic welding system, is adapted to perform the method according to claim 16.

20. Non-transitory computer-readable data storage medium (300) comprising executable program code which, when executed to control a robotic welding system, is adapted to perform the method according to claim 16.

21. Robotic welding system according to claim 12, wherein the sensor unit is configured to repeat the cycle at a frequency between 30 Hz and 300 Hz.

22. Robotic welding system according to claim 12, wherein the sensor unit is configured to repeat the cycle at a frequency between 75 Hz and 125 Hz.
